(19) United States
(12) Patent Application Publication
(10) Pub. No.: US 2013/0025551 A1
(43) Pub. Date: Jan. 31, 2013

(54) TUNING AN OVERHEAD VALVE INTERNAL COMBUSTION ENGINE

(71) Applicant: Thomas E. Ciccarone, West Chester, PA (US)

(72) Inventor: Thomas E. Ciccarone, West Chester, PA (US)

(21) Appl. No.: 13/231,480

(22) Filed: Sep. 13, 2011

Related U.S. Application Data
(60) Provisional application No. 61/512,734, filed on Jul. 28, 2011.

(51) Int. Cl. F01L 1/00; F02N 11/08

(52) U.S. Cl. 123/90.1; 123/179.1

(57) ABSTRACT

In a drag racing vehicle, especially one utilizing a V-block engine, valve gap measurement and adjustment, valve spring force measurement, and the like are carried out with the aid of a foot-operated switch removably connectible to a circuit that carries battery current to the vehicle's starter motor. The foot switch is provided with a cable allowing it to be positioned in either side of the vehicle. Operation of the foot switch effects rotation of the engine crankshaft and camshaft through a small angle so that each valve can be brought to a fully closed condition for measurement or adjustment.

### CROSS REFERENCE TO RELATED APPLICATIONS

This application claims the benefit of the priority of U.S. Provisional Patent Application No. 61/512,734, filed Jul. 28, 2011. U.S. Patent Application No. 61/512,734 is hereby incorporated herein by reference in its entirety.

### FIELD OF THE INVENTION

This invention relates to the tuning of internal combustion engines, and is especially applicable to high performance engines used in automobile racing. The invention relates more particularly to an improved method and apparatus for “bumping” an engine, i.e., rotating the engine crankshaft through small angles in the process of measuring and adjusting valve lash, checking spring pressure, etc.

### BACKGROUND OF THE INVENTION

In automobile racing using a high performance engine having its camshaft inside the engine block, it is important for optimum performance to maintain prescribed clearances between the valves and the rocker arms when the valves are closed. In dragster racing, before a run, a crew member will remove the valve covers while the engine is stopped, and carry out a sequence of measurements, making adjustments and replacing parts, if required. These measurements include valve gap measurements, and frequently also include the checking of valve spring pressure. The measurements are sometimes carried out while the engine is cold. However, in some cases, before the measurements are made, the engine is operated for a time until it reaches its normal operating temperature.

In the process of making these measurements, adjustments, and part replacements, the engine crankshaft must be rotated through a small angle without starting the engine in order to bring each valve to a fully closed condition so that its clearance can be checked and adjusted if necessary, and so that the condition of the corresponding valve spring can be checked. If the rocker arm associated with one of two valves for a given cylinder is pushing down on that valve, the rocker operating the other valve will be in a position such that the gap between the rocker and the valve stem can be checked with a feeler gauge, and the gap can be adjusted if necessary. The small angle rotation of the engine, referred to as “bumping,” can be carried out manually using a hand crank, but is carried out more often by momentary activation of the engine starter using a push-button, with the ignition disabled. The push-button is typically installed permanently in the vehicle, and when pressed, closes a circuit between a battery and the starter motor.

Most rail-type dragsters are powered by large displacement, overhead valve, cam-in-block V-8 engines, now almost always located behind the driver's seat. In some of these dragsters, the engine bumping push-button is mounted on one side of the vehicle, where it can be reached by an individual while making adjustments on the valves on that side, but is not readily accessible when the individual is working on the valves on the opposite side of the engine. If unassisted, the individual must repeatedly move from his working position, cross over to the opposite side of the vehicle, operate the bumping push-button, and return to make measurements and adjustments.

In other rail-type dragsters, the bumping push-button is centrally mounted behind the driver's seat so that it can be reached from either side of the vehicle. In this case, an individual can make measurements and adjustments on one side, and then make similar measurements and adjustments on the other side, bumping the engine as necessary without crossing over repeatedly to the opposite side of the vehicle.

In rail-type dragsters, the engine is mounted as low as possible on the dragster frame in order to maintain a low center of gravity. The valve-operating rockers are therefore usually less than three feet off the ground, and valve measurements and adjustments can be made most accurately and efficiently while the individual making them is seated on a bench or stool on a side of the engine. Thus, unless the individual making the adjustment has simian arms, he will not be able to reach even a centrally located engine bumping push-button while seated in a position for adjustment of the rearmost valves in a valve train. Instead, the individual will need to rise from his seated position, move toward the front of the dragster to reach the centrally mounted push-button, and, while operating the push-button, look back in order to observe the position of the rocker arm associated with a valve adjacent the valve to be adjusted. The need to rise from the seated position repeatedly makes the process of valve adjustment difficult even in the case of a vehicle having a centrally located engine bumping push-button.

In the case of an aluminum engine, the preferred gap between a valve stem and a rocker can be as small as 0.012 inch. The blade of the feeler gauge has a corresponding thickness, and the blade is therefore necessarily very flexible. Accordingly, insertion of blade into the gap, even when the gap is already properly adjusted, usually requires the use of two hands, one to hold the handle of the feeler gauge, and the other to support the blade to prevent it from buckling. Reestablishing a proper two-handed grip on the feeler gauge following each engine bumping step increases the time required to carry out the gap-checking and valve adjusting operation.

Similar difficulties are encountered when checking valve springs using a force measuring gauge. The individual making the measurements will often be unable to reach the engine bumping push-button while seated at in front of the valve spring being measured.

An individual carrying out valve adjustment encounters additional problems. One hand is typically used to hold and manipulate a wrench used to adjust a gap by adjusting the relationship between a rocker arm and its associated pushrod. The other hand is used to hold and manipulate the feeler gauge. As both hands are in use for holding these tools, neither one is free to operate the push-button when proceeding from the adjustment of one valve to the adjustment of another. Therefore, the individual carrying out valve adjustment will need to put down at least one of the tools in order to bump the engine, and will also need to rise from a seated position.

### SUMMARY OF THE INVENTION

This invention addresses one or more of the above-mentioned problems by providing for hands-free bumping of an engine, allowing an individual to use both hands to carry out the gap checking operation, and to remain seated while checking the gaps and adjusting the same for the valve train on each side of the engine.

One aspect of the invention is the process for tuning a vehicular overhead valve internal combustion engine. The process is applicable to an engine equipped with an electric starter motor, two cylinder heads each having a plurality of intake and exhaust valves with valve stems, each intake valve being paired with an adjacent exhaust valve, a spring associated with each valve urging the valve to a closed condition, and a valve-operating mechanism associated with each of the valves. Each valve-operating mechanism is arranged to open its associated valve by pressing on the valve stem thereof, and to allow its associated valve to be closed by an associated valve spring. When a valve is closed, its associated valve-operating mechanism can separate from the valve stem thereof by a short distance whereby a valve gap is established. The engine has a pair of valve covers, each covering one of the two cylinder heads. The valve operating mechanisms are operable by activation of the engine starter motor.

In carrying out the process the valve covers are removed for access to the valve stems. A normally open, foot-operated, momentary electrical switch is connected to a battery and to the starter motor, thereby establishing a circuit whereby operation of the switch will activate the starter motor. An individual selects each of a plurality of the valves for measurement of a parameter associated with each valve of the plurality. The parameter to be measured can be either the size of the gap between the stem of the selected valve and its associated valve-operating mechanism or the spring force exerted by the spring associated with the selected valve. Following selection of each valve of the plurality, the individual operates the starter motor by pressing a foot on the switch, thereby causing the valve-operating mechanism associated with the other valve of the pair that includes the selected valve to open that other valve. The individual checks at least one of the parameters associated with each selected valve.

The individual can remain seated continuously while checking parameters of plural valves, of one of the two cylinder heads.

If the gap associated with each selected valve is checked, the individual can also adjust any one or more of the checked gaps. Preferably, the individual adjusts the gap for a given valve after checking valve gap, by adjusting the relationship between the push rod and rocker arm associated with the valve.

The above-described process is particularly suitable for tuning an eight cylinder, V-block drag racing engine.

Another aspect of the invention is a combination of the foot-operated engine bumping switch with the vehicle. This aspect of the invention can be defined as a combination comprising a vehicle situated on a road surface, the vehicle comprising an internal combustion engine having a rotatable crankshaft and a starter motor, and an engine bumping apparatus comprising an electric storage battery, a normally open, foot-operated, switch disposed on the road surface adjacent the vehicle, and wiring forming an electrical circuit from the battery, through the foot-operated switch to the starter motor, whereby operation of the foot-operated switch causes rotation of the crankshaft by the starter motor.

Here, the installation preferably includes a two terminal connector for removably connecting the foot-operated switch to the electrical circuit. In the case where a manually operable engine bumping push-button is installed in the vehicle, the foot-operated switch is connected electrically in parallel relationship with the manually operable push-button, whereby the manual switch and foot-operated switch can independently close the electrical circuit and thereby activate the starter motor, causing rotation of the engine crankshaft.

While the invention is especially advantageous for pre-race measurement and adjustment of the valves of a rail-type dragster, some of the advantages of the invention can be realized in checking and adjusting valves in other racing vehicles and also in conventional automobiles. The foot-switch according to the invention can also be utilized for checking valve spring force with a spring gauge, and for other procedures in which bumping of an engine is carried out.

Further objects and advantages of the invention will be apparent from the following description when read in conjunction with the drawings.

### BRIEF DESCRIPTION OF THE DRAWINGS

FIG. 1 is a perspective view showing of a drag racing vehicle (“dragster”) being tuned by an individual in the conventional manner;

FIG. 2 is a similar perspective view, showing the individual reaching for an engine bumping push-button;

FIG. 3 is a perspective view showing a drag-racing vehicle being tuned by an individual who can utilize a foot-switch for engine bumping, in accordance with the invention;

FIG. 4 is a schematic diagram of the foot switch and its associated electrical circuitry;

FIG. 5 is a perspective view showing an engine bumping push-button and a plug and socket for removably connecting a foot switch according to the invention in parallel with the push-button; and

FIG. 6 is a schematic cross-sectional view showing an engine cylinder and a valve-operating mechanism including a camshaft, a lifter, a push-rod, a rocker arm, a valve spring, and a valve.

### DETAILED DESCRIPTION OF THE PREFERRED EMBODIMENTS

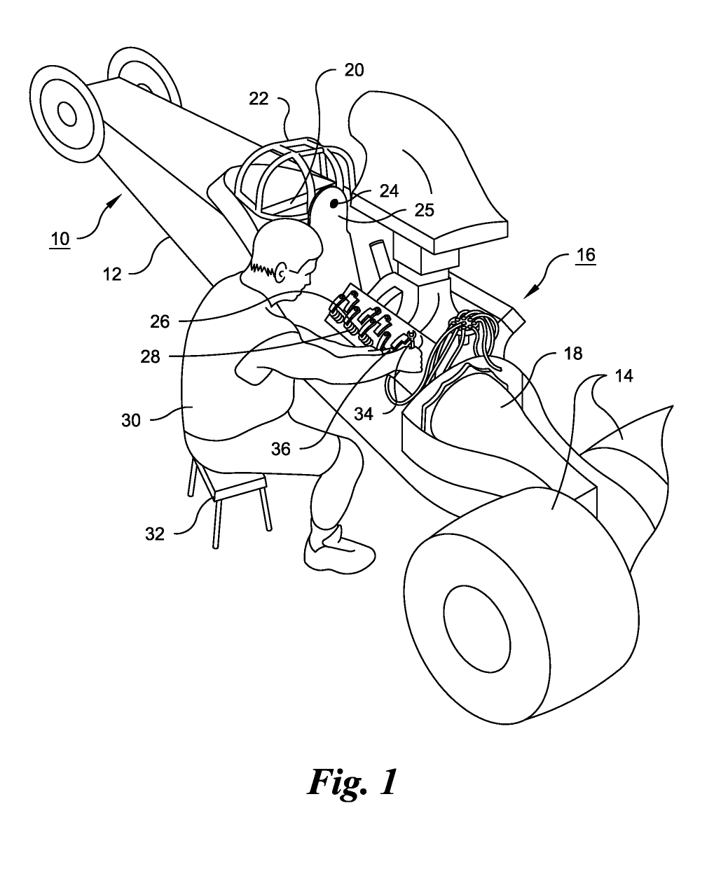

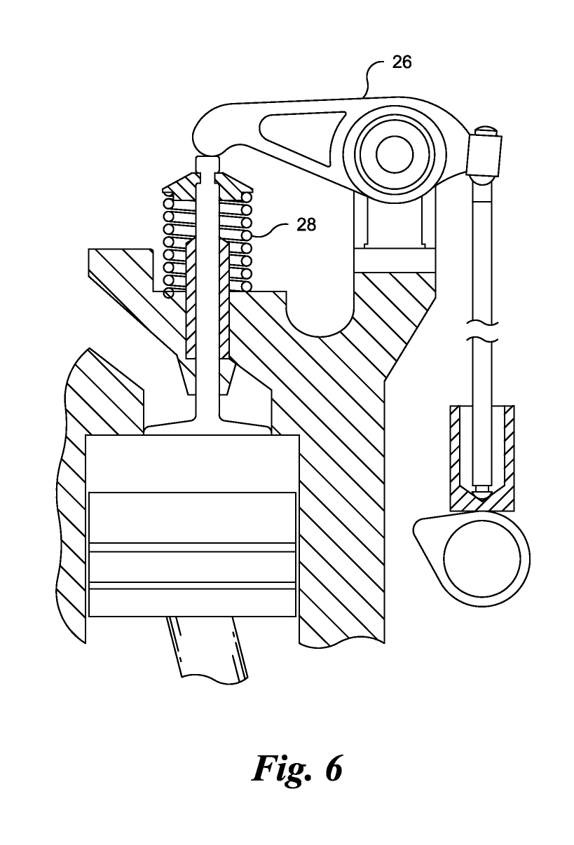

The dragster 10 shown in FIG. 1 comprises a rail frame 12 having a pair of large wheels 14 located at the rear of the vehicle, driven by an engine 16 through a transmission 18. The driver sits on a driver's seat 20, protected by a roll cage 22. An engine bumping push-button 24 is mounted on a panel 26 behind the driver's seat, at a location in front of the engine and at a central location between the sides of the vehicle. The left valve cover has been removed from the engine for access to the valve train, including valve-operating rocker arms, e.g., rocker arm 26, and valve springs, e.g., spring 28, both shown in FIG. 6

As mentioned above, the engine is mounted to keep the center of gravity of the vehicle as low as possible, and the valve train is therefore between about two and three feet above the roadway. A racing crew member 30, seated on a stool 32, is shown adjusting the rearmost intake valve on the left side of the engine using a wrench 34 in his right hand, while holding in his left hand a feeler gauge 36 with its blade between the rocker arm and the intake valve.

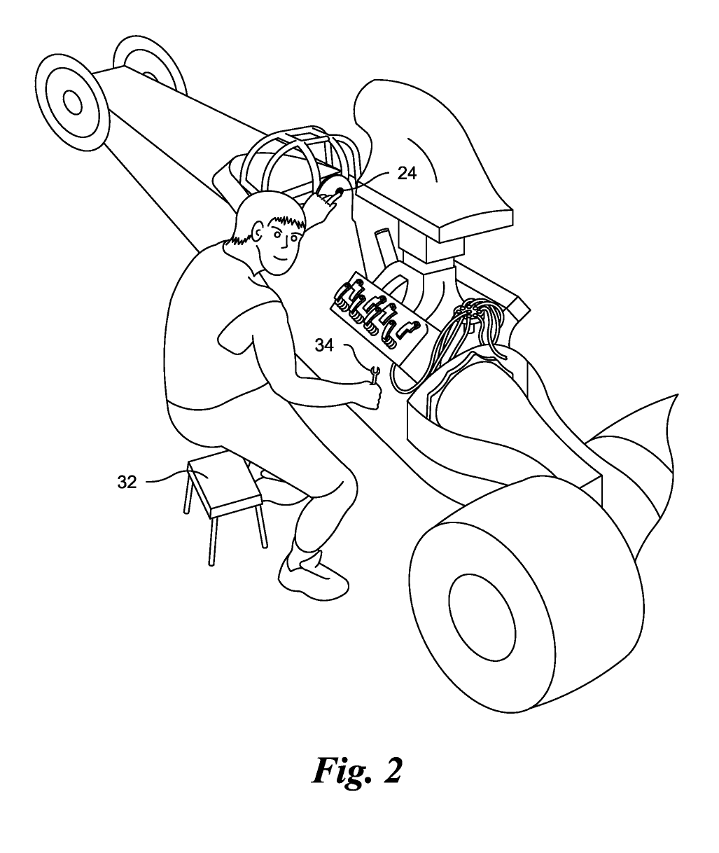

Even though the engine bumping push-button 24 is located a short distance in front of the engine, and mid-way between the sides of the vehicle, the crew member will not be able to remain seated while working on all the valves on one side of the engine. When measuring or adjusting the gap of a valve of a rearmost cylinder, or when checking the force of its spring, the crew member will need to rise from the stool 32, as shown in FIG. 2, in order to reach for the push-button 24 while observing the position of the rocker arm associated with the other valve of the same rearmost cylinder in order to ensure that the valve being checked or adjusted is fully closed.

If the engine bumping push-button is located on one side of the vehicle, checking gaps and adjusting valves becomes even more difficult. The crew member may be able to check and adjust all the valves on one side without rising from a seated position, but, when checking and adjusting the valves on the other side, he will need to cross over repeatedly to the side on which the bumping push-button is located.

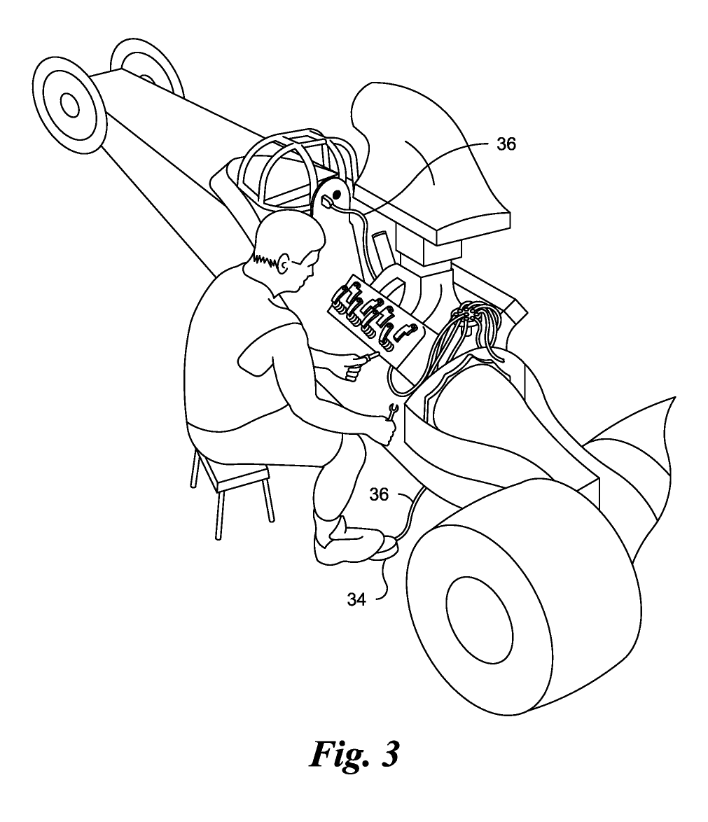

The difficulties described above, which are encountered in measuring valve gaps, adjusting valves, and checking valve spring pressure, are avoided by providing a foot switch 34 as shown in FIG. 3. The foot switch is a normally-open, foot-operated, momentary switch, connected by a cable 36 that it is electrically in parallel with the manual push-button 24. The cable should be sufficiently long that the foot switch can be placed on the roadway, for access from either side of the engine, while remaining connected in parallel with the push-button 24. The foot switch allows the crew member to remain seated while measuring and adjusting valve gaps, and checking valve spring pressure for all of the valves on one side of the engine. The switch can be moved easily to the opposite side of the engine, and used there in the same way.

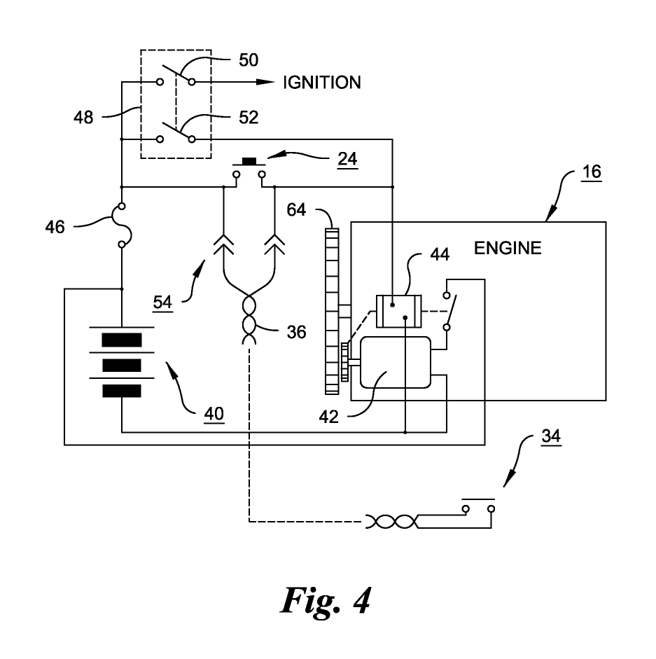

The electrical circuitry by which the foot switch connects the starter motor to a battery is shown schematically in FIG. 4. The negative terminal of a battery 40 is connected to a terminal of a starter motor 42 and also to a terminal of the starter solenoid 44 associated with the motor. The positive terminal is connected through a fuse 46 to the ignition switch 48, which includes a first set of contacts 50 for energizing the ignition coil through a distributor breaker (not shown), and a set of momentary contacts 52 for energizing the starter motor 42 and the starter solenoid 44. The positive terminal of the battery is also connected through the fuse 46 to the engine bumping push-button 24, which is connected in parallel with ignition switch contacts 52.

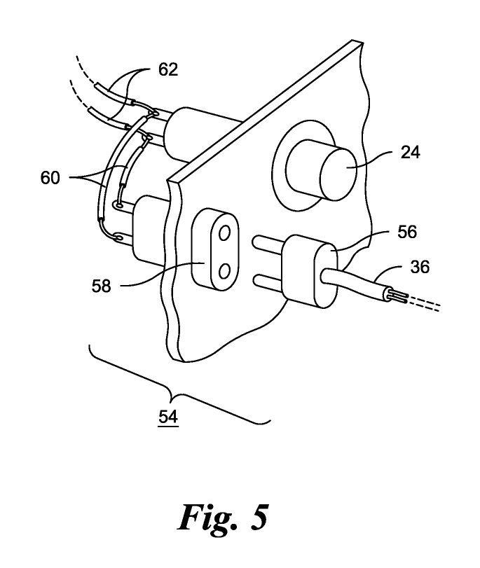

The foot switch 34 is also connected in parallel with the push-button 24 and the momentary contacts 52 of the ignition switch by a connector 54, which consists of a two-terminal plug 56 and a mating two-terminal socket 58, as shown in FIG. 5. FIG. 5 also shows the electrical leads 60, which connect the terminals of socket 58 to the respective contacts of push-button 24, and leads 62, which connect the same terminals to the momentary contacts of the ignition switch.

When the foot switch is depressed, its contacts are closed, and the starter motor and solenoid are energized by battery current. The starter motor engages the engine flywheel 64, rotating the crankshaft, which, in turn, rotates the engine camshaft, operating the valves. By visual observation of the positions of the rocker arms, the crew member can determine that a particular valve is closed (as shown in FIG. 6) and ready for gap measurement, gap adjustment, or spring force measurement.

As will be apparent from the above description, the foot switch allows a racing crew member to carry out engine valve measurement and adjustment procedures more quickly and efficiently by freeing the hands to manipulate a feeler gauge, a valve spring force gauge, or both a feeler gauge and a valve gap adjusting wrench. The foot switch also enables the crew member to work on all the valves on a side of the engine while seated, obviating the step of rising to reach for the bumping push-button when proceeding from one valve to another.

The arrangement of components described and shown in the drawings is one example of a wide variety of arrangements within the scope of the invention. Various modifications can be made, for example, to the electrical circuitry. The battery can be a mounted on the vehicle, or separate from the vehicle in order to reduce weight. The foot switch can be connected in various ways to the battery and starter motor, for example, by connections made through individual connectors such as binding posts or the like. The socket or binding posts to which the foot switch is connected need not be mounted next to the engine bumping push-button. Moreover, the bumping push-button can be eliminated altogether since its function can be accomplished by the foot switch.

The foot-switch according to the invention is applicable not only to rail-type dragsters, but also to other racing vehicles as well as conventional automobiles. Furthermore, the foot-switch can be utilized not only for working on cam-in-block engines, but also for working on overhead cam engines of various kinds.

Numerous other modifications can be made to the apparatus and method described without departing from the scope of the invention as defined by the following claims.

What is claimed is:

1. A process by which an individual tunes a vehicle's overhead valve internal combustion engine having an electric engine starter motor, two cylinder heads each having a plurality of intake and exhaust valves with valve stems, each intake valve being paired with an adjacent exhaust valve, a spring associated with each valve urging the valve to a closed condition, and a valve-operating mechanism associated with each of said valves, each valve-operating mechanism being arranged to open its associated valve by pressing on the valve stem thereof, and to allow its associated valve to be closed by an associated valve spring, wherein when a valve is closed, its associated valve-operating mechanism can separate from the valve stem thereof by a short distance whereby a valve gap is established, a pair of valve covers, each covering one of said two cylinder heads, wherein the valve operating mechanisms are operable by activation of said engine starter motor, the process comprising:
removal of said valve covers for access to said valve stems;
connection of a normally open, foot-operated, momentary electrical switch to a battery and to the starter motor, thereby establishing a circuit whereby operation of said switch will activate the starter motor;
selection, by said individual, of each of a plurality of said valves for measurement of a parameter associated with each valve of said plurality, the parameter being selected from the group consisting of the gap between the stem of the selected valve and its associated valve-operating mechanism and the spring force exerted by the spring associated with the selected valve;
following selection of each valve of said plurality, operation, by said individual, of the starter motor by pressing with one's foot on the switch, thereby causing the valve-operating mechanism associated with the other valve of the pair that includes the selected valve to open said other valve, and checking, by said individual, of at least one of said parameters associated with each selected valve.

2. The process of claim 1, wherein said individual remains seated continuously while checking parameters of at least two of the valves of one of said two cylinder heads.

3. The process of claim 1, wherein in the checking step, said individual checks at least the valve gap of each selected valve.

4. The process of claim 3, wherein, after checking at least one valve gap, said individual adjusts said at least one valve gap.

5. The process of claim 4, wherein said engine comprises an engine block and includes a cam located within the engine block, said valve operating mechanism associated with each valve comprises a rocker arm arranged to press on a valve stem, a lifter operable by the cam, and a push rod extending from said lifter to the rocker arm, and wherein said individual adjusts said at least one valve gap by adjusting the relationship between said push rod and said rocker arm.

6. The process of claim 1, wherein said engine is an eight cylinder, V-block engine.

7. In combination with a vehicle situated on a road surface, said vehicle comprising an internal combustion engine having a rotatable crankshaft and a starter motor, an engine bumping apparatus comprising an electric storage battery, a normally open, foot-operated, switch disposed on said road surface adjacent said vehicle, and wiring forming an electrical circuit from said battery, through said foot-operated switch to said starter motor, whereby operation of said foot-operate switch causes rotation of said crankshaft by said starter motor.

8. The combination of claim 7, including a two terminal connector for removably connecting said foot-operated switch to said electrical circuit.

9. The combination of claim 7, including a manually operable push-button connected electrically in parallel relationship with said foot-operated switch, whereby the manual switch and foot-operated switch can independently close said electrical circuit and thereby activate the starter motor, causing rotation of the engine crankshaft.

10. The combination of claim 9, including a two terminal connector for removably connecting said foot-operated switch to said electrical circuit.
